(19) United States
(12) Patent Application Publication
(10) Pub. No.: US 2010/0253840 A1
(43) Pub. Date: Oct. 7, 2010

(54) AUTOMATIC DETECTION OF GRAPHICS FORMAT FOR VIDEO DATA

(75) Inventor: JAMES E. NAVE, DENTON, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INC, DALLAS, TX (US)

(21) Appl. No.: 12/418,712

(22) Filed: Apr. 6, 2009

(51) Int. Cl. H04N 5/04; H04N 7/12; H04N 5/66

(52) U.S. Cl. 348/500; 375/240.25; 348/739; 375/E07.027; 348/E05.133; 348/E05.009

(57) ABSTRACT

A method for automatic format detection, video decoder and video display devices therefrom. A video input having an algorithm-based first graphics format is received that carries an RGB video signal, Hsync signal and a Vsync signal. From the Hsync signal and Vsync signal, a plurality of different measured timing parameters are generated including a total number of vertical lines per frame, a total number of vertical lines per pulse width of the Vsync signal, a total number of reference clock cycles per vertical line, and measured polarity information for the Vsync and Hsync signal. An algorithm automatically generates a format detection result that represents the first graphics format using the plurality of different measured timing parameters and the measured polarity information, including a plurality of horizontal and vertical timing information for configuring a video display for the algorithm-based first graphics format.

### FIELD

Embodiments of the present invention relate to automatic format detection for displaying video data on video display units.

### BACKGROUND

As known in the art, graphics format detection of an incoming video data stream or video signal is generally needed to properly display an image of the information on a video display unit. The graphics format can generally be one of a large number of available graphic formats.

The Video Electronics Standards Association (VESA) released a Coordinated Video Timing (CVT) Standard. The CVT Standard provides a method for generating a consistent and coordinated set of standard graphic formats, display refresh rates, and timing specifications for display systems and serves as a PC Graphics Standard. The CVT Standard compliant graphic formats are defined by applying VESA-CVT compliant timing parameters to a set of standard equations. As such, there are a large number of CVT Standards compliant graphic formats that can be made available for implementation in video display systems. R, G, and B component video signals are used for VESA-CVT compliant graphics formats.

Conventional graphics format detection schemes generally measure a plurality of parameters associated with the video input and compare the parameters obtained to format parameter data sets stored in a look-up table. The format parameter set that is determined to be the closest is then selected and sent to a video display for use in rendering an image from the video data provided on a suitable display screen. As known in the art, if the format parameter set selected is not very close to actual format parameters of the video input, the image quality will generally suffer. Moreover, the look-up table approach relies on a large look-up table to include data entries to support the large number of available graphic formats and in some cases certain graphic formats anticipated to be implemented. Such a large look-up table generally needs an undesirable large amount of memory for storing the look-up table data, In addition, look-up tables cannot be conveniently updated (e.g. without a firmware change) to support new graphics formats which are not supported by the look-up table provided.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

A method for automatic format detection and video decoder and video display device therefrom. A video input having an algorithm-based first graphics format is received that carries an RGB video signal, Hsync signal and a Vsync signal. From the Hsync signal and Vsync signal, a plurality of different measured timing parameters are obtained including a total number of vertical lines per frame (including active lines and blanking lines), a total number of vertical lines per pulse width of the Vsync signal, a total number of reference clock cycles per vertical line, and measured polarity information for the Vsync and Hsync signal. An algorithm automatically generates a format detection result that represents the first graphics format using the plurality of different measured timing parameters and the measured polarity information, wherein the format detection result includes a plurality of horizontal and vertical timing information for configuring a video display for said algorithm-based first graphics format.

The algorithm-based first graphics format can comprise a VESA-CVT compliant format. In another embodiment, the algorithm-based first graphics format can comprise a non VESA-CVT compliant format generated with at least one non-standard VESA-CVT timing parameter applied into the VESA-CVT algorithm (which as known in the art includes a plurality of equations). The plurality of different measured timing parameters and polarity information can both be obtained exclusively from the Hsync signal and Vsync signal.

In embodiments of the invention the algorithm can employ dyadic fractions, wherein the algorithm converts all decimal fractions to their nearest equivalent dyadic fraction. This embodiment allows embodiments of the invention to be implemented on low-cost fixed point processors.

### BRIEF DESCRIPTION OF THE DRAWINGS

Embodiments will be described with reference to the following drawing figures, in which like numerals represent like items throughout the figures, and in which:

FIG. 1 is a block diagram of a video display system including a video decoder with an automatic format detector according to an embodiment of the invention.

FIG. 2 is a block diagram of a video decoder chip that includes an automatic format detector formed on-chip, according to another embodiment of the invention.

FIG. 3 is a flow chart depicting an exemplary automatic graphics format detection method according to an embodiment of the invention.

FIG. 4 shows definitions for constants used in equations provided herein that are used for CVT compliance, according to an embodiment of the invention.

FIG. 5 shows definitions for variables used in equations provided herein, according to an embodiment of the invention.

FIG. 6 shows examples of constants expressed as nearest equivalent dyadic fractions that enables implementing algorithms to be performed on low-cost fixed point processors, according to an embodiment of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Embodiments of the present invention relate to systems and methods for automatic detection of an algorithm-based graphics format for video data provided by a video source having a video graphics adapter (e.g. from a video card of a personal computer (PC). The method embodiments generally involve receiving one or more video comprising input signals and synchronization signals comprising Vsync and Hsync. The methods also generally involve generating a plurality of different measured timing parameters including a total number of vertical lines per frame (including active lines and blanking lines), a total number of vertical lines per pulse width of the Vsync signal, a total number of reference clock cycles per vertical line, and polarity information for the Vsync and Hsync signal, from the Vsync and Hsync signal. An algorithm automatically generates a format detection result that represents the first graphics format using the plurality of different measured timing parameters and the measured polarity information, wherein the format detection result includes a plurality of horizontal and vertical timing information for configuring a video display for said algorithm-based first graphics format.

One example of algorithm-based graphics format standards for video data that embodiments of the present invention generally support are VESA-CVT Standard compliant graphic formats. The VESA-CVT Standard is described in the following document, Coordinated Video Timings Proposed Standard, Version 1.2, Draft 1, Sep. 1, 2004. Some of the graphics formats specified in the VESA-DMT standard are VESA-CVT compliant formats. The VESA DMT Standard is described in the following document, VESA and Industry Standards and Guidelines for Computer Display Monitor Timing (DMT), Version 1.0, Revision 12 (2008). The VESA-DMT standard also includes some formats that are generated using the VESA-CVT algorithm that are not VESA-CVT compliant because they utilize a non-standard vertical refresh rate of 120 Hz. Embodiments of the invention generally support all graphics formats generated using the VESA-CVT algorithm including non VESA-CVT compliant formats generated with at least one non-standard VESA-CVT timing parameter applied into the VESA-CVT formula. As should be understood, an aspect ratio describes the ratio of horizontal to vertical dimensions of the active video portion of the display screen. Aspect ratios supported by embodiments of the invention include, but are not limited to, a 4:3 aspect ratio, a 16:9 aspect ratio, a 16:10 aspect ratio, and a 15:9 aspect ratio.

As described below, embodiments of the present invention can also support graphic formats having either Standard Blanking Formats or Reduced Blanking Formats. Standard Blanking Formats and Reduced Blanking Formats are well known to those having ordinary skill in the art. These Blanking formats have different values for certain parameters (e.g., horizontal blanking interval, vertical blanking interval, and pixel frequency).

Embodiments of the present invention will now be described more fully hereinafter with reference to accompanying drawings, in which illustrative embodiments of the invention are shown. Embodiments of the invention, however, may be embodied in many different forms and should not be construed as limited to the embodiments set forth herein. For example, the present invention can be embodied as a method, a data processing system, or an embedded firmware product. Accordingly, embodiments of the present invention can take the form as an entirely hardware embodiment, an entirely software embodiment, or a hardware/software embodiment.

Before describing the tangible and method embodiments of the present invention, it will be helpful in understanding an exemplary environment in which the invention can be utilized. In this regard, embodiments of the present invention can generally be utilized in any application where the graphics format of video data is desired to be automatically determined. Such applications include, but are not limited to, television sets having a PC graphics input, a video monitor having a PC graphics input, a PC monitor, and a converter box (e.g. VGA to YPbPr component video conversion).

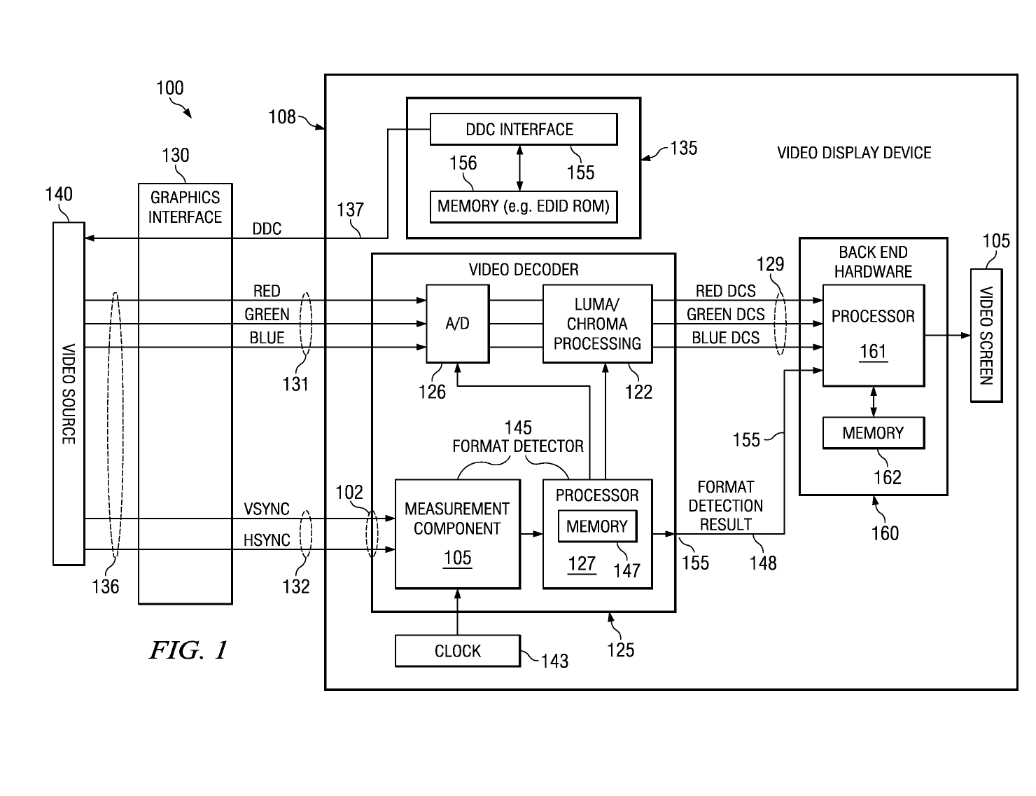

FIG. 1 is a block diagram of a video display system 100 including a video display device 108 that comprises a non-volatile memory device with interface 135, video decoder 125 including automatic format detector 145, backend device 160, and video screen 105, according to an embodiment of the invention. A video source 140 is coupled by a graphics interface 130 to the video display device 108. The video source 140 provides a graphics output in an algorithm-based first graphics format characterized by a plurality of graphics format parameters. The video source 140 can be, but is not limited to, a video card associated with a Digital Video Disc (DVD), a Video Home System (VHS), a computer (e.g. PC), a video game console, or a device maintained by a video information service provider (e.g., a cable service provider). The video source 140 provides a video comprising output 136 comprising video signals shown as RGB video signals 131 and synchronization signals 132 shown as separate Hsync and Vsync signals. The RGB video signal 131 defines the content that is to be displayed to a user (not shown) on the video screen 105.

Graphics interface 130, such as a VGA cable, couples the RGB video signal 131 and synchronization signals 132 to the analog to digital (A/D) converter 126 an automatic format detector 145, respectively, of video decoder 125. Non-volatile memory device with interface 135 comprises a display data channel (DDC) interface 155 and non-volatile memory 156. Graphics interface 130 also couples DDC data 137 stored in memory 156 of the non-volatile memory device with interface 135, such as the EDID ROM memory shown in FIG. 1, to the video source 140.

Video decoder 125 includes at least one A/D converter 126, and a luma/chroma processing block 122 coupled to outputs of the A/D converter 126. The A/D converter 126 receives the video comprising input having an algorithm-based first graphics format characterized by a plurality of graphics format parameters carrying an RGB video signal 131. After processing by luma/chroma processing block 122, video decoder 125 outputs a digitized version of the RGB video signal 131 shown as Red DCS, Green DCS and Blue DCS (collectively, (DCSs 129). The A/D converter 126 shown comprises three separate A/Ds, one for each color signal (R,G, and B). The A/D 126 generally provides at least eight-bit resolution, for high-fidelity and high-definition video display functionality.

Video decoder also comprises an automatic format detector 145 comprising measurement component 105 coupled to a processor 127 for automatic format detection using the respective SYNC signals. Automatic format detector 145 includes at least one input 102 which is operable to couple the Vsync and Hsync signals to measurement component 105. Clock 143 is generally utilized by measurement component 105 for timing measurements. Measurement component 105 can be embodied as hardware, such as in the case of an analog comprising input 136. Measurement component 105 can also be embodied as software, such as in the case of a digital comprising input 136. In another embodiment, measurement component 105 includes both software and hardware.

Measurement component 105 measures a plurality of different timing parameters generally comprising a total number of vertical lines per frame including active lines and blanking lines, a total number of vertical lines per pulse width of the Vsync signal, a total number of reference clock cycles per vertical line, and polarity information comprising a polarity for said Vsync signal, and a polarity for said Hsync signal.

Processor 127 has associated memory 147. Processor 127 receives the measured timing parameters and measured polarity information from measurement component 105 and implements the automatic detection algorithm to provide a format detection result 148 at its output 155. Processor 127 can be an embedded processor, such as an embedded RISC CPU such as an ARM processor. In a particular embodiment, the automatic detection algorithm can be implemented on either an ARM-7 fixed-point processor 127 embedded in the video decoder 125. Alternatively, the processor for implementing the automatic detection algorithm can be embedded in the back-end device 160 described below, such as embodied as an ARM-9 floating-point processor.

Backend device 160 is coupled to drive the video screen 105 and comprises a backend processor 161 having associated memory 162, and a first input coupled to an output of the video decoder 125 for receiving the DCSs 129 and another input for receiving the format detection result 148 from processor 127. The backend processor 161 is operable for generating video content from DCSs 129 and format detection result 148 and providing the video content generated to the video screen 105. Although the format detection result 148 is shown provided by processor 127 as being part of the video decoder 125, the format detection algorithm could alternatively be implemented on the back-end processor 161, which is where most conventional format detection algorithms are implemented.

Video display device 108 can generally comprise a variety different of display devices. Exemplary Video Display Types include Cathode Ray Tube (CRT), Liquid Crystal Display (LCD), Plasma Display and Digital Light Processing (DLP) Display. The video display device 108 can also comprise wireless device, such as a personal digital assistant or a conventional wireless computing device.

Automatic format detection according to embodiments of the invention generally only needs Hsync and Vsync information, such as in the form of Hsync and Vsync inputs in the case of analog video input. From Hsync and Vsync information using embodiments of the invention, as described below, the following seven (7) different parameters can be determined.

| Parameter abbreviation | Parameter description |
|---|---|
| HSYNC_DET | horizontal sync activity detection |
| VSYNC_DET | vertical sync activity detection |
| TOTAL_V_LINES | total number of vertical lines per frame |
| TOTAL_H_REF_CLKS | total number of reference clock cycles per |
| | vertical line |
| V_SYNC_RND | vertical sync width in vertical lines |
| VSYNC_POL | vertical sync polarity |
| HSYNC_POL | horizontal sync polarity |

Embodiments of the invention described below generally use the above seven (7) parameters to determine the current graphics format. A change in one or more of these seven (7) values can be used to indicate a format change.

In the embodiment of the invention shown in FIG. 1, the video comprising input 136 comprises a 5-wire analog input that provides R,G,B information in the form of analog RGB component video signals and synchronization signals in the form of Vsync and Hsync signals. Digital RGB component video signals may also be supported by embodiments of the invention. For example, if the D/A converter in the video source 140 is replaced with an HDMI/DVI transmitter and the A/D converter 126 in the video display device 108 is replaced with an HDMI/DVI receiver, then HDMI/DVI interfaces can generally be supported. DVI and HDMI TX/RX devices are basically SERDES (serializer/de-serializer) devices. The DVI/HDMI TX serializes the video data and the RX de-serializes the video data. Both DVI and HDMI generally support RGB component video data with discrete Syncs including VESA-CVT compliant formats.

The format detection result 148 output by processor 127 that represents the automatically determined graphics format of the video comprising signal 136 can be in a variety of different forms. In one embodiment the format detection result 148 comprises an identification (ID) code, such as a binary code. The ID codes can be based on existing ID codes from a known standard, such as VESA-DMT or VESA-CVT, or be a collection of custom IDs created that are unique to a particular application. Exemplary ID codes include a DMT 1-byte code, standard 2-byte ID code, CVT 3-byte code, or a proprietary ID code. Respective ID codes can correspond to measured and calculated graphics format parameter data (e.g. pixels/line, lines/frame) stored in a data structure. The data structure generally includes fields representing various format specific parameters determined by the format detection algorithm, such as frame rate, total number of pixels per vertical line, and total number of vertical lines per frame, which can be stored in a memory, such as memory 147 associated with processor 127. In one specific embodiment, the format detection result is a data structure stored in on-chip RAM and accessible via an external I²C interface.

Upon detection of a format change, such as a change beyond a predetermined threshold of at least one of the seven (7) parameters described above, a new (updated) data structure can be communicated to backend hardware 160. In one arrangement, the data structure is communicated by I²C to the backend hardware 160. In another embodiment, the format detection result 148 can comprise the actual plurality of measured and calculated graphics format parameters.

In one embodiment of the invention, for the specific case of analog component video signal, the algorithm generally implements Sync Activity Detection. Activity detection on the two discrete synchronization signal inputs is typically used to determine whether the video comprising input 136 (e.g. PC graphics input) is configured as a 3-wire, 4-wire, or 5-wire interface. If activity is detected on the VSYNC input, the graphics input is determined to be configured as a standard 5-wire interface and automatic format detection is used. If activity is detected on the HSYNC/CSYNC input but not on the VSYNC input, the PC graphics input is determined to be configured as a standard 4-wire interface. If activity is not detected on either the HSYNC/CSYNC input or the VSYNC input, the PC graphics input is determined to be configured as a standard 3-wire interface. In this case, it is assumed that Sync-On-Green (SOG) is being used for horizontal and vertical synchronization. Embodiments of the invention are generally not applied if the interface is determined to be a 3 or 4-wire interface.

| | HSYNC/CSYNC | |
|---|---|---|
| VSYNC input | input | |
| Activity | Activity | Graphics |
| Detection | Detection | Interface Type |
| 1 | don't care | 5-wire |
| 0 | 1 | 4-wire |
| 0 | 0 | 3-wire |

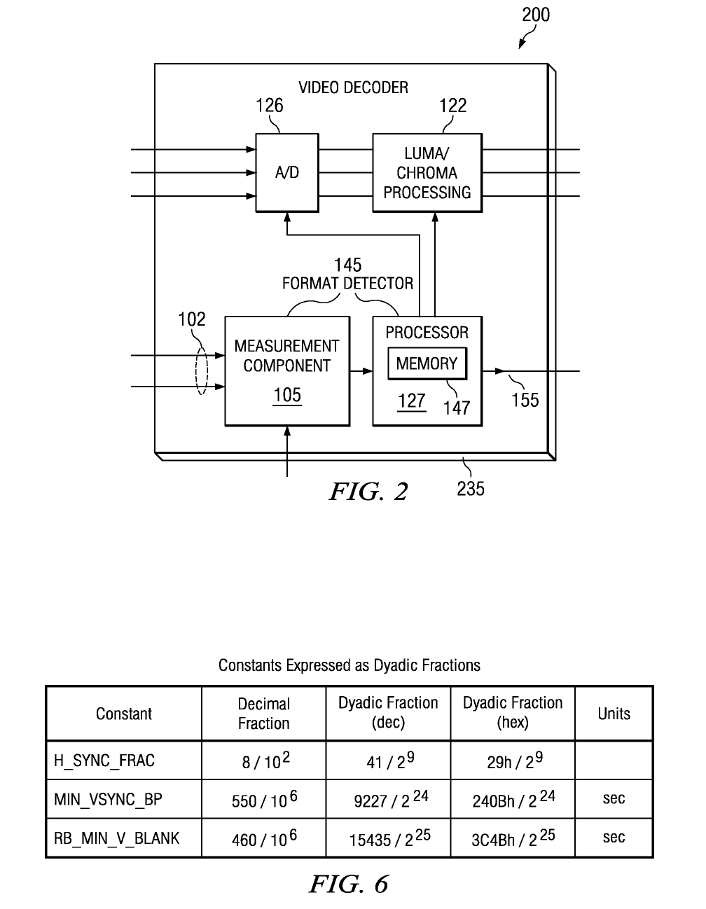

FIG. 2 is a block diagram of a video decoder chip 200 that includes an automatic format detector 145 according to an embodiment of the invention. In this embodiment the video decoder components comprising A/D 126 and luma/chroma processing block 122 and automatic format detector 145 components comprising measurement component 105 and processor 127 with memory 147 are all formed on the same substrate 235. Substrate 235 includes a semiconductor surface. Clock 143 shown in FIG. 1 utilized by measurement component 105 can be entirely on video decoder chip 200, or embodied externally, such as by an external clock or external crystal. As described below, since automatic format detection algorithms according to embodiments of the invention can be operable with a single (i.e. only one) integer division, automatic format detectors according to embodiments of the invention are generally well suited even for applications having limited processing capabilities (e.g. fixed point processor).

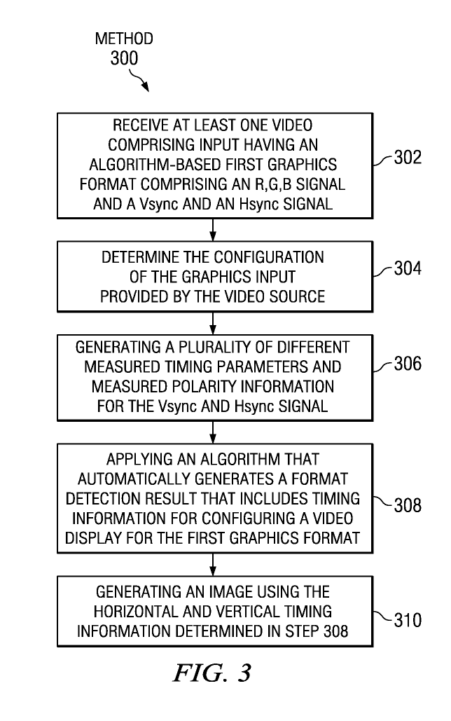

FIG. 3 is a flow chart depicting an exemplary automatic graphics format detection method 300 according to an embodiment of the invention. Step 302 comprises receiving at least one video comprising input having an algorithm-based first graphics format characterized by a plurality of graphics format parameters, the video comprising input carrying video data comprising an RGB signal and a Vsync and Hsync signal. The algorithm-based first graphics format is generally, but not necessarily, an unknown format.

In some embodiments of the invention the video source provides video/graphics format information along with the video data. For example, HDMI generally includes a Video ID code (VIC) within the Auxiliary Video Information (AVI) InfoFrame which is sent during the blanking interval. These Video ID codes are defined in the CEA-861 standard for both DVI and HDMI. This allows the video source to directly communicate the video/graphics format being used to the video display device. However, even if the video/graphics format is provided to the video display device an automatic format detection scheme would still be needed to generate graphics format information for the display device to make an image in certain instances, such as when the VIC data is missing or when the video source is using a graphics/video format that is not defined in the latest version of the CEA-861 standard (currently Revision E). Moreover, it might be more efficient to support a large number of VESA-CVT compliant formats using an automatic detection algorithm according to an embodiment of the invention rather than using the VIC provided together with a conventional look-up table.

Step 304 comprises the optional step of determining the configuration of the graphics input provided by the video source. For example, in the case of standard analog RGB component video, as described above, step 304 can comprises determining whether activity is detected on the Vsync input. If activity is determined to be present on the Vsync input, it can be concluded the graphics input is a standard 5-wire interface having separate R,G, B, and Vsync and Hsync signals. If activity is not determined to be present on the Vsync input for standard analog component video, it is determined that the graphics input is configured as a standard 3 or 4 wire interface.

Step 306 comprises generating a plurality of different measured timing parameters and measured polarity information from the Vsync signal and the Hsync signal. The measured timing parameters generally comprise a total number of vertical lines per frame (including active lines and blanking lines), a total number of vertical lines per pulse width of the Vsync signal, a total number of reference clock cycles per vertical line.

Step 308 comprises applying an algorithm that directly generates a format detection result that represents the first graphics format using the plurality of different measured timing parameters and the measured polarity information, wherein the format detection result includes a plurality of horizontal and vertical timing information for configuring a video display for the algorithm-based first graphics format. The algorithm based first graphics format can comprise an algorithm-based first graphics format, such as a VESA-CVT format or a format generated with at least one non-standard VESA-CVT timing parameter applied into the VESA-CVT formula. Step 310 comprises generating an image on a screen of a video display device using the horizontal and vertical timing information determined in step 308.

Embodiments of the invention have a wide variety of applications. Some exemplary applications for embodiments of the invention include television sets (video display with a TV tuner) with a PC graphics input, video monitor (video display without a TV tuner) with PC graphics input, PC monitor and a Converter Box (e.g. VGA to YPbPr component video conversion).

### EXAMPLES

The following Examples are provided in order to further illustrate embodiments of the invention. The scope of the present invention, however, is not to be considered limited in any way by the Examples provided.

This Example details the computational steps, suitable for being run on a processor having an algorithm stored in associated stored memory in firmware.

### Computation of Common Timing Parameters

This section details the computational steps that are common to both the standard blanking and reduced blanking scenarios and are generally performed first.
1. Find the total number of reference clock cycles per frame:

TOTAL_{—}V_{—}REF_{—}CLKS=TOTAL_{—}H_{—}REF_{—}CLKS*TOTAL_{—}V_LINES
2. Find the nominal vertical frame rate (arbitrarily assumes a 27 MHz reference clock):

V_FIELD_RATE_{—}RQD=IF(TOTAL_{—}V_{—}REF_{—}CLKS>511071, 50, IF(TOTAL_{—}V_{—}REF_{—}CLKS>466071, 56, IF(TOTAL_{—}V_{—}REF_{—}CLKS>432692, 60, IF(TOTAL_{—}V_{—}REF_{—}CLKS>400549, 65, IF(TOTAL_{—}V_{—}REF_{—}CLKS>380357, 70, IF(TOTAL_{—}V_{—}REF_{—}CLKS>367500, 72, IF(TOTAL_{—}V_{—}REF_{—}CLKS>338824, 75, IF(TOTAL_{—}V_{—}REF_{—}CLKS>293824, 85, IF(TOTAL_{—}V_{—}REF_{—}CLKS>247500, 100, 120)))))))))
3. Find the horizontal frequency from the nominal vertical frame rate (V_FIELD_RATE_RQD) and the measured total number of vertical lines per frame (TOTAL_V_LINES):

H_{—}FREQ_{—}EST=V_FIELD_RATE_{—}RQD*TOTAL_{—}V_LINES
4. Find the numerator of the aspect ratio from the measured vertical sync width (V_SYNC_RND):

ASPECT_RATIO_{—}H=IF(V_{—}SYNC_{—}RND=10, IF(AND(TOTAL_{—}V_LINES>=1063, TOTAL_{—}V_LINES<=1100), 409600, 393216), IF(V_{—}SYNC_{—}RND=7, IF(AND(TOTAL_{—}V_LINES>=790, TOTAL_{—}V_LINES<=867), 436907, 327680), IF(V_{—}SYNC_{—}RND=6, 419431, IF(V_{—}SYNC_{—}RND=5, 466034, 349526))))

### Computation of Standard Blanking Timing Parameters

5. Find the minimum number of lines during the vertical blanking interval: (MIN_V_PORCH_RND=3, MIN_VBPORCH=6)

MIN_{—}VBI_LINES=MIN_{—}V_PORCH_{—}RND+V_{—}SYNC_{—}RND+MIN_{—}VBPORCH+1
6. Find the number of lines during the vertical blanking interval: (MIN_VSYNC_BP=550/10⁶)

VBI_LINES=MAX(ROUNDDOWN(H_FREQ_{—}EST*MIN_{—}VSYNC_{—}BP, 0)+MIN_{—}V_PORCH_{—}RND+1, MIN_{—}VBI_LINES)
7. Find the number of lines during the active video portion of the frame:

V_LINES=TOTAL_{—}V_LINES−VBI_LINES
8. Find the number of pixels during the active video portion of the line (rounded down to the nearest cell width): Note: ASPECT_RATIO_V=2¹⁸

TOTAL_ACTIVE_PIXELS=CELL_{—}GRAN*ROUNDDOWN(V_LINES*ASPECT_RATIO_{—}H/ASPECT_RATIO_{—}V/CELL_{—}GRAN, 0)
9. Find the minimum horizontal frequency (M_PRIME=300, C_PRIME=30, DUTY_CYCLE_MIN=20)

H_{—}FREQ_MIN=1000*M_PRIME/(C_PRIME−DUTY_CYCLE_MIN)=30000 (constant)
10. Find the number of pixels in horizontal blanking (rounded down to 2 times the nearest cell width):

H_BLANK=2*CELL_{—}GRAN*ROUNDDOWN(TOTAL_ACTIVE_PIXELS*(C_PRIME*MAX(H_{—}FREQ_{—}EST, H_{—}FREQ_MIN)−M_PRIME*1000)/((100−C_PRIME)*MAX(H_{—}FREQ_{—}EST, H_{—}FREQ_MIN)+M_PRIME*1000)/(2*CELL_{—}GRAN), 0)
11. Find the total number of pixels per line:

TOTAL_PIXELS=TOTAL_ACTIVE_PIXELS+H_BLANK
12. Find the number of pixels in the Horizontal Sync period and Horizontal Back Porch (rounded down to the nearest cell width):

H_{—}SYNC_{—}BP=CELL_{—}GRAN*ROUNDDOWN(TOTAL_PIXELS*H_{—}SYNC_{—}FRAC/CELL_{—}GRAN, 0)+(H_BLANK/2)
13. Find the number of lines in the Vertical Sync period and Vertical Back Porch: (MIN_V_PORCH_RND=3)

V_{—}SYNC_{—}BP=VBI_LINES−MIN_{—}V_PORCH_{—}RND

### Computation of Reduced Blanking Timing Parameters

14. Find the minimum number of lines during vertical blanking interval: (RB_V_FPORCH=3, MIN_VBPORCH=6)

MIN_{—}VBI_LINES=RB_{—}V_{—}FPORCH+V_{—}SYNC_{—}RND+MIN_{—}VBPORCH
15. Find the number of lines during the vertical blanking interval: (RB_MIN_V_BLANK=460/10⁶)

VBI_LINES=MAX(ROUNDDOWN(H_{—}FREQ_{—}EST*RB_MIN_{—}V_BLANK, 0)+1, MIN_{—}VBI_LINES)
16. Find the number of lines during the active video portion of the frame:

V_LINES=TOTAL_{—}V_LINES−VBI_LINES
17. Find the number of pixels during the active video portion of the line:

TOTAL_ACTIVE_PIXELS=CELL_{—}GRAN*ROUNDDOWN(V_LINES*ASPECT_RATIO_{—}H/ASPECT_RATIO_{—}V/CELL_{—}GRAN, 0)
18. Find the total number of pixels per line:

TOTAL_PIXELS=TOTAL_ACTIVE_PIXELS+RB_{—}H_BLANK
19. Find the number of pixels in the Horizontal Sync period and Horizontal Back Porch: (RB_H_SYNC=32, RB_H_BLANK=160)

H_{—}SYNC_{—}BP=RB_{—}H_{—}SYNC+(RB_{—}H_BLANK/2)=112 (constant)
20. Find the number of lines in the Vertical Sync period and Vertical Back Porch: (RB_V_FPORCH=3)

V_{—}SYNC_{—}BP=VBI_LINES−RB_{—}V_{—}FPORCH

### Computation of Additional Common Timing Parameters:

This section details the computational steps that are also common to both the standard blanking and reduced blanking scenarios, and is generally performed last.
21. Find the estimated pixel clock frequency (Hz):

PIXEL_{—}FREQ_{—}EST=TOTAL_PIXELS*LINE_RATE_HZ
Noted: In general, the number of total pixels per line (TOTAL_PIXELS) is generally needed to program the feedback divider of the horizontal PLL in the display. For some PLLs the estimated pixel clock frequency (PIXEL_FREQ_EST) may also be needed to enable adjusting certain PLL settings (e.g. charge pump current) for a particular frequency range.
22. Find the actual pixel clock frequency (MHz) rounded down to the nearest 0.25 MHz:

ACT_PIXEL_{—}FREQ=CLOCK_STEP*ROUNDDOWN(PIXEL_{—}FREQ_{—}EST/10⁶/CLOCK_STEP, 0)
Note: In general, the actual pixel clock frequency (ACT_PIXEL_FREQ) rounded to the nearest 0.25 MHz is not required by the display. It is provided here only as a way to easily verify the accuracy of this automatic format detection scheme against the VESA-CVT standard.
From the actual pixel frequency (ACT_PIXEL_FREQ), the actual horizontal frequency and actual field/frame rate can be determined, if desired.

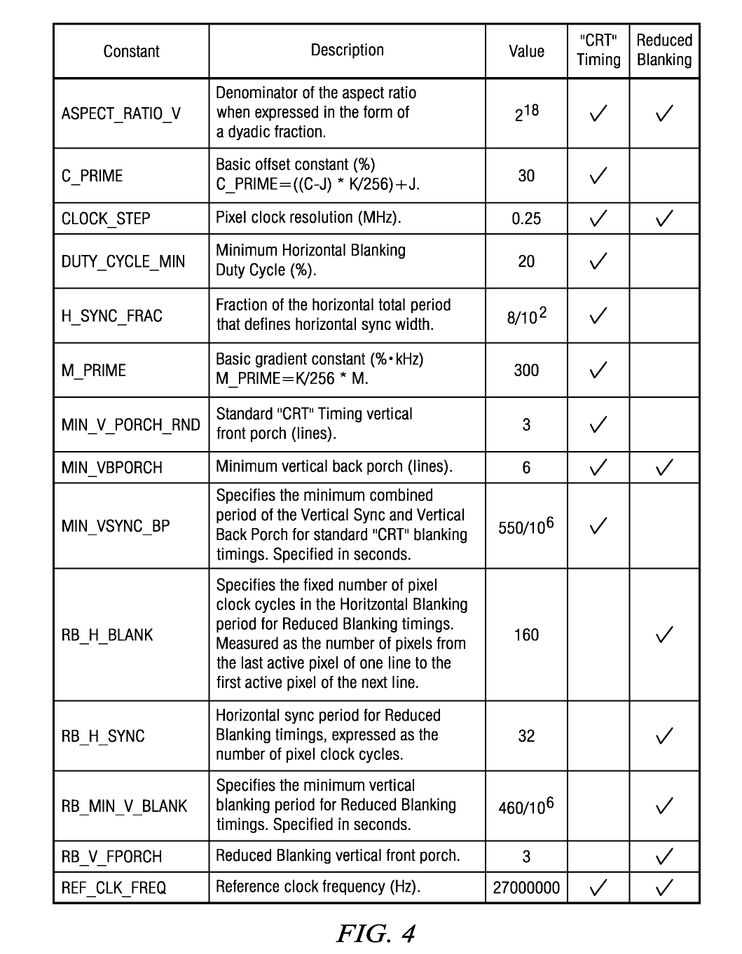

FIG. 4 shows definitions for constants used in equations provided herein, according to an embodiment of the invention. The constants shown include a basic offset constant “C_PRIME” that is expressed in % and a basic gradient constant “M_PRIME” that is expressed as % kHz. A relation that permits calculation for each of these constants is shown in FIG. 4. The values shown in FIG. 4 are used for CVT compliance. If other values are used for these constants then the resulting parameter calculations will not be CVT compliant. Although one embodiment of this invention uses the values provided in FIG. 4, embodiments of the invention are not limited to any particular values.

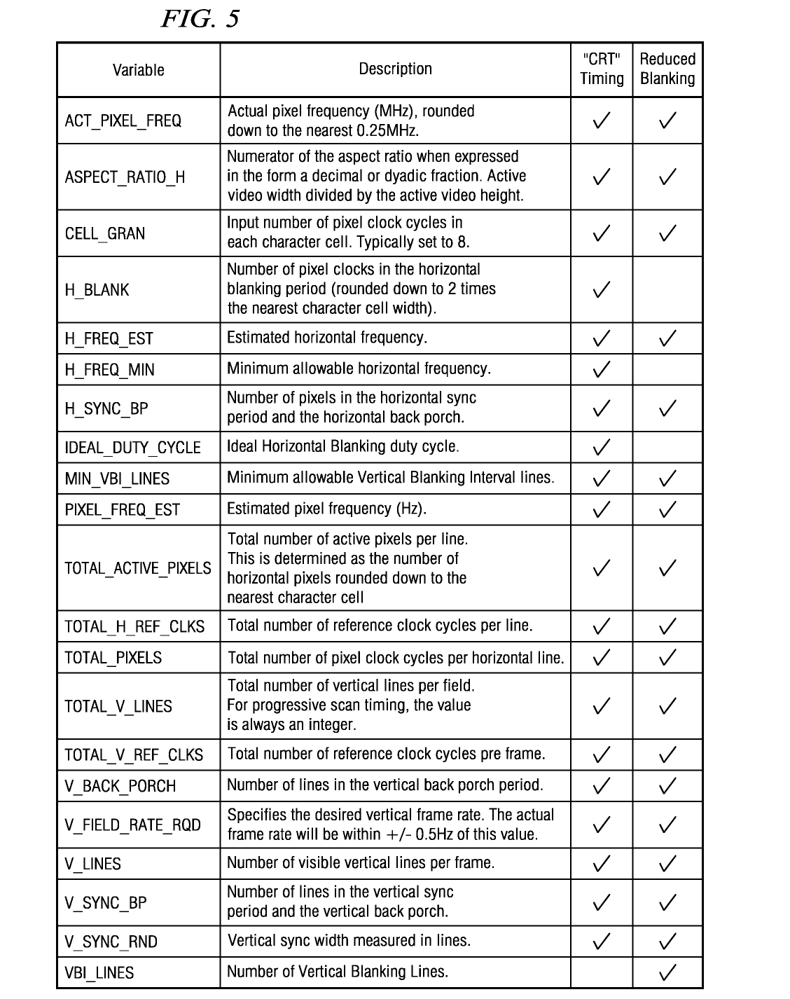

FIG. 5 shows definitions for variables used in equations provided herein, according to an embodiment of the invention. The variables shown include an input number of pixel clock cycles in each character cell “CELL_GRAN” that as noted in FIG. 5 is typically set to 8.

To enable implementing the algorithm on a low-cost fixed point processor, decimal fractions are converted to their nearest equivalent dyadic fraction according to an embodiment of the invention as shown in FIG. 6. For the three constants shown in FIG. 6, in one embodiment of the invention the nearest equivalent dyadic fraction is used rather than the decimal fraction specified in the VESA-CVT standard. In regards to all dyadic fractions, embodiments of the invention are not limited to any particular number of bits of precision.

In light of the forgoing description of the invention, it should be recognized that the present invention can be realized in hardware, software, or a combination of hardware and software. A method for automatically detecting a graphics format for video data according to the present invention can be realized in a centralized fashion in one processing system, or in a distributed fashion where different elements are spread across several interconnected processing systems. Generally, any kind of computer system, or other apparatus adapted for carrying out the methods described herein, can be used. A typical combination of hardware and software could be a general purpose computer processor, with a computer program that, when being loaded and executed, controls the computer processor such that it carries out the methods described herein. Of course, an application specific integrated circuit (ASIC), and/or a field programmable gate array (FPGA) could also be used to achieve a similar result.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others having ordinary skill in the art upon the reading and understanding of this specification and the annexed drawings. In addition, while a particular feature of the present invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

I claim:

1. A method for automatic format detection for video data, comprising:
receiving at least one video comprising input having an algorithm-based first graphics format characterized by a plurality of graphics format parameters, said video comprising input carrying an RGB video signal, an Hsync signal and a Vsync signal;
from said Hsync signal and said Vsync signal, generating a plurality of different measured timing parameters comprising a total number of vertical lines per frame including active lines and blanking lines, a total number of said vertical lines per pulse width of said Vsync signal, a total number of reference clock cycles per said vertical line, and measured polarity information comprising a polarity for said Vsync signal, and a polarity for said Hsync signal, and
applying an algorithm that directly and automatically generates a format detection result that represents said first graphics format using said plurality of different measured timing parameters and said measured polarity information, said format detection result including a plurality of horizontal and vertical timing information for configuring a video display for said algorithm-based first graphics format.

2. The method of claim 1, wherein said algorithm-based first graphics format comprises a VESA-CVT compliant format.

3. The method of claim 1, wherein said algorithm-based first graphics format comprises a non VESA-CVT compliant format generated with at least one non-standard VESA-CVT timing parameter.

4. The method of claim 3, wherein said non-standard timing parameter comprises an aspect ratio, a vertical refresh rate, a basic offset constant, or a basic gradient constant.

5. The method according to claim 1, wherein said plurality of different measured timing parameters and said measured polarity information are both obtained exclusively from said Hsync signal and said Vsync signal.

6. The method according to claim 1, wherein said video comprising input comprises analog RGB component video.

7. The method according to claim 1, wherein said video comprising input comprises digital RGB component video.

8. The method according to claim 1, wherein said algorithm employs dyadic fractions, wherein all decimal fractions are converted to their nearest equivalent dyadic fraction.

9. The method according to claim 1, wherein said horizontal timing information of said format detection result comprises horizontal timing parameters expressed in pixel clock cycles or multiples thereof, said horizontal timing parameters comprising at least one of a total number of pixels per vertical line, a total number of active pixels per vertical line, or a total number of pixels per horizontal blanking interval.

10. The method according to claim 1, wherein said vertical information of said format detection result comprises vertical timing parameters expressed in said vertical lines or multiples thereof, said vertical timing parameters comprising at least one of said total number of vertical lines per frame, a total number of active vertical lines per frame, and a total number of said vertical lines per vertical blanking interval.

11. The method according to claim 1, wherein said format detection result comprises at least one of a vertical refresh rate and a horizontal line frequency.

12. A video decoder having automatic format detection, comprising:
at least one analog to digital (A/D) converter for receiving a video comprising input having an algorithm-based first graphics format characterized by a plurality of graphics format parameters carrying an RGB video signal, an Hsync signal and a Vsync signal and outputting a digitized version of said RGB video signal;
a luma/chroma processing block coupled to an output of said A/D converter for receiving said digitized version of said RGB video signal and outputting a red digital component signal, a green digital component signal, and a blue digital component signal, and
an automatic graphics format detector, comprising:
a measurement component operable for receiving said Hsync signal and said Vsync signal and from said Hsync signal and said Vsync signal generating a plurality of different measured timing parameters comprising a total number of vertical lines per frame including active lines and blanking lines, a total number of said vertical lines per pulse width of said Vsync signal, a total number of reference clock cycles per said vertical line, and measured polarity information comprising a polarity for said Vsync signal, and a polarity for said Hsync signal; and
a processor coupled to an output of said measurement component, said processor applying an algorithm that directly and automatically generates a format detection result that represents said first graphics format using said plurality of different measured timing parameters and said measured polarity information, said format detection result including a plurality of horizontal and vertical timing information for configuring a video display for said algorithm-based first graphics format.

13. The video decoder of claim 12, further comprising memory for storing said algorithm as firmware.

14. The video decoder of claim 12, wherein said processor consists of a single fixed point processor.

15. The video decoder of claim 12, wherein said algorithm employs dyadic fractions, wherein said algorithm converts all decimal fractions to their nearest equivalent dyadic fraction.

16. The video decoder of claim 12, further comprising a substrate including a semiconductor surface, wherein said video decoder is built in or on said semiconductor surface.

17. The video decoder of claim 12, wherein said horizontal timing information of said format detection result comprises horizontal timing parameters expressed in pixel clock cycles or multiples thereof, said horizontal timing parameters comprising at least one of a total number of pixels per vertical line, a total number of active pixels per vertical line, or a total number of pixels per horizontal blanking interval.

18. The video decoder of claim 12, wherein said vertical information of said format detection result comprises vertical timing parameters expressed in said vertical lines or multiples thereof, vertical timing parameters comprising at least one of said total number of vertical lines per frame, a total number of active vertical lines per frame, and a total number of said vertical lines per vertical blanking interval.

19. A video display device, comprising:
a video screen for displaying video content;
a video decoder having automatic format detection, comprising:
at least one analog to digital (A/D) converter for receiving a video comprising input having an algorithm-based first graphics format characterized by a plurality of graphics format parameters carrying an RGB video signal, an Hsync signal and a Vsync signal and outputting a digitized version of said RGB video signal;
a luma/chroma processing block coupled to an output of said A/D converter for receiving said digitized version of said RGB video signal and outputting a red digital component signal, a green digital component signal, and a blue digital component signal, and
an automatic graphics format detector, comprising:
a measurement component operable for receiving said Hsync signal and said Vsync signal and from said Hsync signal and said Vsync signal generating a plurality of different measured timing parameters comprising a total number of vertical lines per frame including active lines and blanking lines, a total number of said vertical lines per pulse width of said Vsync signal, a total number of reference clock cycles per said vertical line, and measured polarity information comprising a polarity for said Vsync signal, and a polarity for said Hsync signal; and
a first processor coupled to an output of said measurement component, said processor applying an algorithm that directly and automatically generates a format detection result that represents said first graphics format using said plurality of different measured timing parameters and said measured polarity information, said format detection result including a plurality of horizontal and vertical timing information for configuring said video screen for said algorithm-based first graphics format, and
a backend device coupled to drive said video screen comprising a backend processor having an input coupled to an output of said video decoder for receiving said format detection result and said digital component signals, said backend processor operable for generating said video content therefrom and providing said video content to said video screen.

20. The video display device of claim 19, wherein said first processor consists of a single fixed point processor.

21. The video display device of claim 19, wherein said algorithm employs dyadic fractions, wherein said algorithm converts all decimal fractions to their nearest equivalent dyadic fraction.

22. The video display device of claim 19, wherein said horizontal timing information of said format detection result comprises horizontal timing parameters expressed in pixel clock cycles or multiples thereof, said horizontal timing parameters comprising at least one of a total number of pixels per vertical line, a total number of active pixels per vertical line, or a total number of pixels per horizontal blanking interval.

23. The video display device of claim 19, wherein said vertical information of said format detection result comprises vertical timing parameters expressed in said vertical lines or multiples thereof, vertical timing parameters comprising at least one of said total number of vertical lines per frame, a total number of active vertical lines per frame, and a total number of said vertical lines per vertical blanking interval.
